(19) United States
(12) Patent Application Publication
(10) Pub. No.: US 2008/0140579 A1
(43) Pub. Date: Jun. 12, 2008

(54) PAYMENT SYSTEM FOR TRAVELERS AND OTHER CHECKS AND A DEBIT CUM CREDIT CARD

(76) Inventor: Agarwal Sanjiv, Calcutta (IN)

Correspondence Address: SANJIV AGARWAL, 25C/1 BELVEDERE ROAD , CALCUTTA 700027, INDIA, CALCUTTA, 700027, omitted

(21) Appl. No.: 11/951,424

(22) Filed: Dec. 7, 2007

(30) Foreign Application Priority Data
Dec. 7, 2006 (IN) 1317KOL/06

(51) Int. Cl. G06Q 20/00; G06Q 30/00; H04L 9/32

(52) U.S. Cl. 705/76; 705/39; 705/14; 705/45; 705/78

(57) ABSTRACT

A merchant discount is levied on receiving payments through Traveler's and other checks, from which a consumer reward is funded. A line of credit is extended in a conventional bank deposit account with checking option. When a check payable from such an account is presented, it is processed as a debit transaction if the funds are available from the deposits, and as a credit if it is paid from the line of credit. A debit-cum-credit card is also issued and processed through the payment system networks in the same way as above. A merchant discount is levied in each case, which may be higher in credit and lower in debit. A different level of reward incentive linked to each payment may then be awarded to the consumer, funded from the savings in processing each transaction. In addition, in a new method of check payment on the Internet, the payer writes an original check on a special form, scans and sends the scan and other check data to a payment server, which in turn produces an image replacement document to process it as a substitute check.

THIS APPLICATION CLAIMS PRIORITY OF Indian Patent Application No: 1317/KOL/06 of Jul. 12, 2006 FILED IN INDIA PATENT OFFICE

### BACKGROUND OF APPLICATION

1. Field of Invention

The present invention relates to the fields of computerized banking technology, payment systems and consumer rewards programs.

2. Background and Prior Art

Checks are a popular form of making payments. These are paper instructions to pay utilizing banking channels and processes rather than paying by currency notes and coins. These are governed under negotiable instrument laws.

Traveler's checks are sold by a financial institution to consumers: against full value of the check and generally a commission added; i.e. the payer buys the check by depositing full amount and a service charge in advance. The check has the amount imprinted on it signifying its par value. It has all other features of a conventional check such as a MICR number, date etc and has security printing features. A space for writing payees name and signature of the payer is provided. An additional space for writing the signature of the payer again in the presence of the payee is provided in traveler's check only, as an additional security feature.

A conventional check such as those utilized through a checking account are printed forms, on which a spaces are provided for the payer to write the name of payee, the amount the date of payment and the signature of the payer. A banker's cashier's check is a guaranteed demand draft issued by a bank to a consumer against full payment of the value.

The checks are processed through a complex web of banking system evolved over a long period of time. The basic aspect of the process involves the payee depositing the check in his bank for collecting proceeds from the payer, the payee's bank presenting the check to a clearinghouse, the clearinghouse in turn presenting the payer's bank for payment, the payer's bank checking the check is free on any defect and there is availability of funds in the payer's account and then paying payee's bank through clearinghouse, or returning the check unpaid if any of these are missing. The payee's bank on receipt of payment confirms credit on his account or reverses the credit by debiting if the check is returned unpaid, often also debiting a bounced check fee. A huge number of such checks involving a large volume of money is transacted in this way. Since there are relatively much fewer banks than the number of payers and payees, these transactions involve a lot of contra transactions between the banks e.g. bank A owing money to bank B in one transaction and vice-versa in another. By using the techniques of reconciliation by netting clearing and settlement, the huge number of individual transactions as per the checks is bundled into a few consolidated transactions between the banks. This entire processing is at par i.e. there is no deduction of any amount generally, neither from payer not payee, because it is assumed that banks participating in the system will make tip for the cost of processing checks by way of other opportunity costs on the consumers, such as interest lost in deposits left with the banks to pay for the checks issued, etc. However, there may be some small service charges levied on the payer but payee generally will get the full value at par, unless his bank deducts a charge in extraordinary situations like additional cost involved in sending an outstation check and collecting proceeds against it.

The latest advancement in check payment are electronic check presentment (ECP) by which an electronic image of the check replaces the paper instrument, rest of the processes remaining the same. Another electronic method of electronic conversion e.g. check truncation at POS, by which the check is processed instantly as if a card transaction, through a computerized network such as those of ACH and VISA POS.

In card based payment systems instead of handing over of check by the payer to the payee, the payee presents a card as a token for being eligible to instruct the issuer financial institution that had issued the card, to pay. The card carries some information that are captured and transmitted along with the amount required to be paid, electronically from payee's counter to the payer's bank account, and utilizing modern telecommunication and computer technology, the whole transaction is instantly settled and a signature of the payer is taken on an acknowledgement slip just to record that he has authorized the transaction. A big difference in this system is that a discount is deducted from the payee in lieu of this service, which is sizeable viz. around 2% of the value of the transactions on an average. This discount is shared between the card payment entities—generally a merchant acquirer, a clearinghouse such as VISA and a card issuer. A reward incentive may be issued to payer generally from this commission or from other earnings from the cardholder such as interest on revolving credit.

Thus there is an incentive for the payer to pay with credit card whereas there is a disincentive for the payee to receive payment through cards because his net is reduced. Surveys by a reputed body like AFP have revealed that the merchants' preference of payment methods is in the order of Cash, Checks, Debit Card and Credit Cards. But since there is no or lesser incentive for the payer to pay by the former methods, the latter have gained more ground in terms of consumer habits. The payment system data suggest a gradual substitution of checks by cards. This is undesirable from merchants' point of view. A huge infrastructure exists for processing of checks. Check issuers maintain checking accounts with amounts saved and deposited, which in turn promote savings and investment. Therefore it is desirable that checking accounts and checks as a payment method is promoted.

In the United States Published Patent Application 200050021405 of the present inventor incorporated herein by reference, differential incentives based on payment modes is disclosed. It involves merchant funding an incentive to the payer, by rewarding values inversely related to each payment processing cost of the payee.

In U.S. Pat. No. 5,798,508 Walker et al has disclosed Postpaid Traveler's Checks issued against an amount held or locked in a Credit Card account and processed through card payment networks when presented for cashing.

In the United States Published Patent Application 20020040344 Preiser, Randall F. et al has disclosed a Check guarantee, verifications processing, credit reports and collection system and method awarding purchase points for usage of checks. This is limited to enrolling customers in a check verification service and awarding loyalty points for doing so.

### SUMMARY OF THE INVENTION

In one aspect, the present invention contemplates collecting a payment-processing fee from merchants, on being presented with checks issued to them by consumers. Such fee can be higher in case of a guaranteed check such as a traveler's check or a draft and lower in case of a usual check. Such a fee may be in the form of a merchant discount that is generally applied in card transactions.

In another aspect the invention, disclosed is a process for using bank accounts for both debit or credit transactions, collecting differential merchant discounts on debit and credit transactions and issuing different rewards to consumers. A line of credit is extended in a conventional bank deposit account with checking option. When a check payable from such an account is presented, the same is processed as a debit transaction if the funds are available from the deposits, and as a credit if it is paid from the line of credit, on deposit being insufficient. A debit-cum-credit card is preferably issued and processed through the payment system networks in the same way as above. A merchant discount is levied in each case, which may be higher in credit and lower in debit transactions.

A reward incentive linked to each payment may be then awarded to the consumer making the payment. The reward may be differentiated in each situation as above, funded from the savings made in processing each transaction, or other incomes like interest earned on credit extended.

In yet another aspect of the invention, an improved method of payment by checks on the Internet is disclosed, whereby the payer writes the check manually, scans the check and sends the scan to a payment server on the network. In addition, the payer also keys in check data like payee, amount, date and MICR codes etc. manually. The scan and the data then are used by the payment server to generate an IRD for processing the check in the ACH or as a substitute check in clearing.

One of the prime objectives of the invention is to promote paper checks and checking accounts in banking and the related payment systems, which are increasingly facing competition from plastic credit cards and their payment networks.

### BRIEF DESCRIPTION OF DRAWINGS

FIGS. 1 & 2 are flowcharts showing basic steps in the process

FIG. 3A is an example statement of account of a merchant

FIG. 3B is an example statement of account of a consumer

FIG. 4A is an example of the front side of a check with a guaranteed maximum value

FIG. 4B is an example of the backside of the check

FIG. 5 is a set of example GUI for check payment on Internet

FIG. 6 is a flowchart showing basic steps in an example check payment on Internet

FIG. 7 is a scheme diagram of example check payment on the Internet

FIG. 8 is a flowchart of an example process for electronic issuance of checks

### DETAILED DESCRIPTION

Disclosed below is a new process of deducting a merchant discount and awarding differential incentives on traveler's checks and other checks processed in banking payment system.

In one aspect, the invention deals with traveler's checks. The traveler's checks may be issued in three ways: a) As a banker's or cashier's check, on receiving full amount and b) Like a) except the amount is held ‘locked’ in an interest bearing account and actually debited on being cashed, and c) the checks are issued pursuant to a line of credit extended to the account holder and on being cashed an interest is levied till the credit extended is repaid.

There may be an agreement with merchants that a discount e.g. 2% will have to be paid by them each time they receive proceeds against such checks, out of which a portion may be used to fund an incentive, back to the consumer depositing the check. This can be achieved by: I) Direct agreement with merchants who will honor such checks, to pay 2% on collection of the par value; II) Agreement with merchants' acquirer banks to deduct a service fee say 2% each time they present and collect proceeds against such checks. A portion of this, say 1% may then be retained by the merchant's bank and rest 1% remitted to the issuer of the checks.

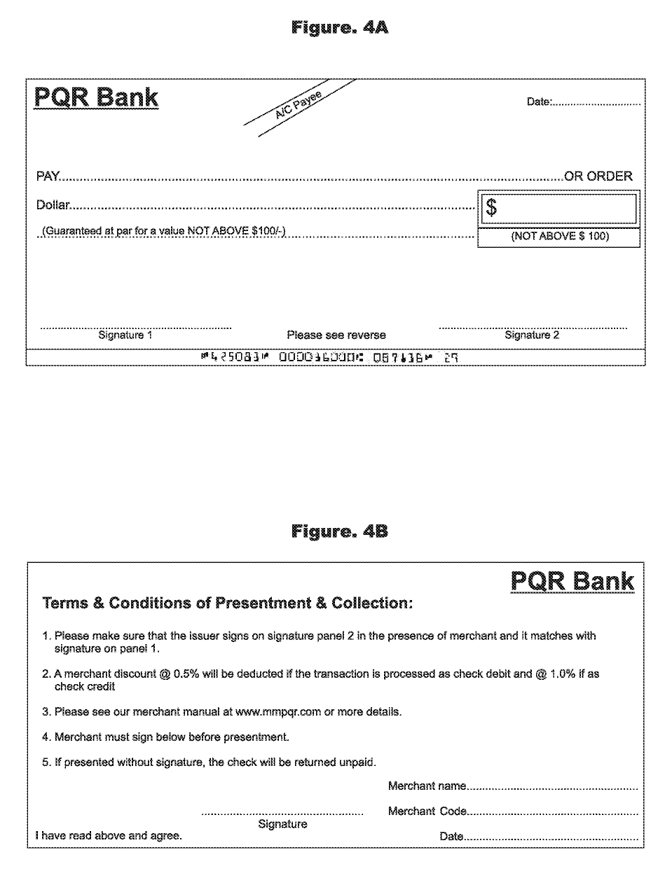

Such terms and conditions of presentment may be imprinted at the back of the check issued, to form an agreement with payee merchant and/or his bank, as shown in FIGS. 4A and 4B.

There is a merchant saving in processing check payments received vis-à-vis card payments. As a result, the merchant may agree to a deduction to the extent that his net remains more or less at the same levels as credit card transactions say around 98%. But since the banking payment systems are programmed to process payments at par, the payment to the merchant's bank will be at par i.e. 100% out of which he will return a discount say 2% which can be utilized further to fund an incentive to the payer, directly or through the issuer of checks or through a third party merchant acquirer.

In one embodiment, a customer is offered a checking account with a line of credit in the form of an overdraft limit. When the customer pays through a check of such an account, his banks processes the check on being presented by determining if the payment is to be made as a debit from deposit available or a credit from the line if the funds are not available in the deposit. The payee's bank then accordingly levies a lower fee on the merchant it the amount is processed as debit and higher if as credit. The two kinds of fees as above may be similar to or lesser than those on debit and credit card transactions, say 1% and 2% respectively, though this is not a limitation. Since the merchant perceives a credit transaction more favorably because it is considered to create a ‘float’ in the purchasing power of the consumer, he accepts a greater deduction in such transactions, like he does in credit card transactions vis-à-vis debit card. Likewise, since a guaranteed check such as a traveler's check may be most preferable by the merchant, he may accept an even greater deduction say 2.5% on the same.

In another embodiment, there may be different levels of rewards associated with the above situations. If the reward is offered by the bank, it could be in a direct proportion of the fees deducted from the merchant, e.g. cash-back of 0.5% in debit, 1% in credit and 1.5% in guaranteed checks processed as above. However, if the reward is issued by the merchant it could be inversely related to the merchant cost of receiving the payment. For example it could be cash-back of 2% in debit, 1% in credit and 0.5% in guaranteed check payments, as above.

There could be further discounting as per contract, to find additional incentives such as cash back e.g. 5%, tied to payment with checks of such checking accounts, from time to time and with specified merchants participating in such promotions. At present such schemes are limited to spending linked to certain cards only, because there is no known method of a merchant or a bank funding an incentive linked to payment by a check.

In another embodiment, a Debit-cum-Credit Card may be issued to holders of such accounts and the transactions processed as debit card transaction if the funds are available, or as a credit card transaction if the funds are insufficient and paid from the line of credit extended, in the first and the second situations in the above mentioned examples. The customer presents such card for payment which is conventionally processed through electronic data capture (EDC) at the POS and the associated payment system networks such as the electronic find transfer (EFT) networks and automated clearinghouse (ACH) networks e.g. those used for ATM and debit card transactions, including STARS NYCE, Pulse and the likes. In this case a PIN is additionally required to be provided. However, the same transactions can be also processed as signature based transactions routed through credit card payment systems such as those of VISA, MC, Discover etc. An important difference will be that the payment processor program while authorizing payment from the issuer of the card such as a bank also collects the information if the same is to be posted as a debit or credit transaction. The issuer bank program upon checking the amount of the transaction and whether the same is paid from deposits available or from the line of credit extended, marks the transaction as debit or credit respectively. If the transaction is marked as a debit transaction a first interchange discount fee is deducted from the merchant and if the transaction is marked as a credit transaction a second interchange discount fee is deducted from the merchant. Such first and the second interchange discount fees may be similar to those levied on conventional debit and credit card transactions. The first interchange fees in case of debit transaction is generally lower than the second one in case of a credit transaction e.g. 1% and 2% respectively. Since the merchant's net in the two situation is different viz. 99% and 98% respectively, the merchant may decide to fund a differential reward in both the situations say a cash back of 2%, and 1% respectively. In this case an additional first amount in case of debit and a second amount in case of the credit transaction may be additionally deducted from the merchant by a reward administrator in the payment system network, to fund a first reward incentive to the consumer in case of a debit and a second reward incentive in case of a credit transaction. The first amount may be greater than the second and the two rewards also in the same proportion, so that the merchant's net remains similar more or less. For example, in case of a debit transaction the interchange discount fee and reward cash-back to the consumer may be 1% and 2% respectively whereas in case of a credit transaction the same may be 2% and 1% respectively, so that the merchant's net remain the same i.e. 97%. The reward administrator may be a separate entity with a separate reward server in the payment system network or an existing entity like the merchant acquirer or the card issuer. If the reward administrator is the issuer bank, the deduction from the merchant may be same in both situations e.g. 3% but a different incentive is rewarded to the consumer e.g. cash-back of 2% and 1% respectively in debit and credit transaction. In another example situation, the issuer bank may provide additional rewards on credit transactions, funded from the interest earnings on the credit extended. However, if an incentive is to be provided: by the payer's banks it could be lesser on debit and higher on credit, because of greater earning in the later, in terms of merchant discount as well as possibility of earning interest, as shown in FIG. 2B. The detailed workings of payment system networks as above is disclosed in the published application number 20050021405 of the present inventor and is incorporated herein by reference. Sometimes PIN and Signature based debit card transactions are also referred colloquially as ‘debit’ and ‘credit’ respectively but the two terms are used in a different sense above, meaning payment from deposit balance available or from a line of credit advanced, respectively.

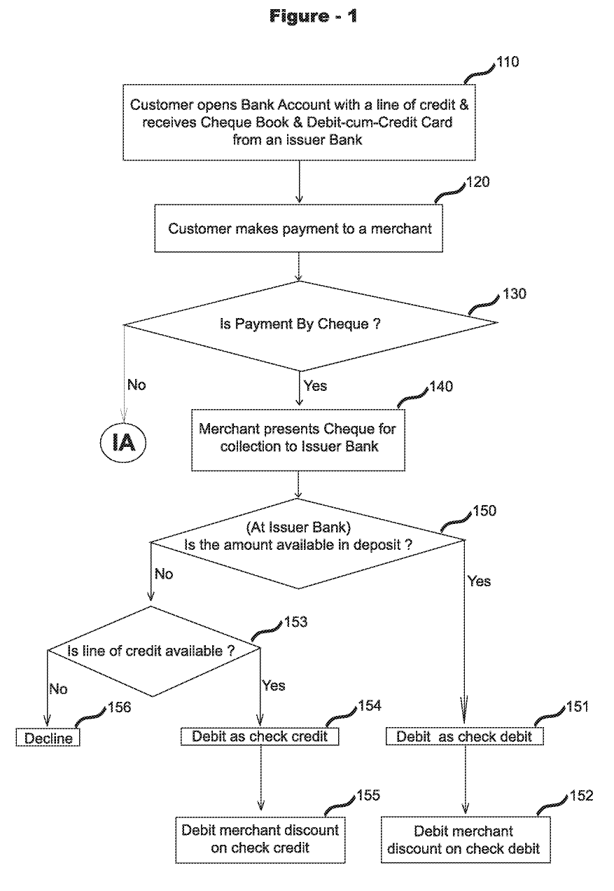

FIGS. 1 and 2 are simple flowcharts detailing basic steps in the above process. A customer opens a deposit account with a line of credit and is issued a checkbook and a debit-cum-credit card (110). The customer uses one of these at a merchant (120). Merchant's bank sends the transaction to customer's issuer bank, through bank clearing or payment system networks, if the payment is through check or card respectively (140,165). The customer's issuer bank program makes a determination (150, 170) whether the payment can be processed as a debit (151,171) or credit (154,174) transaction, depending on the availability of deposit or a line of credit respectively, sufficient to honor the payment. On completion, the customer's bank debits the customer and credits the merchant accordingly. Additionally, the issuer bank debits the merchant with a discount depending on the type of transaction (152,155,172,175). He may also credit the customer with a reward, as explained above. However, a different entity in the payment system such as a merchant acquirer or a reward administrator can issue a reward to the consumer.

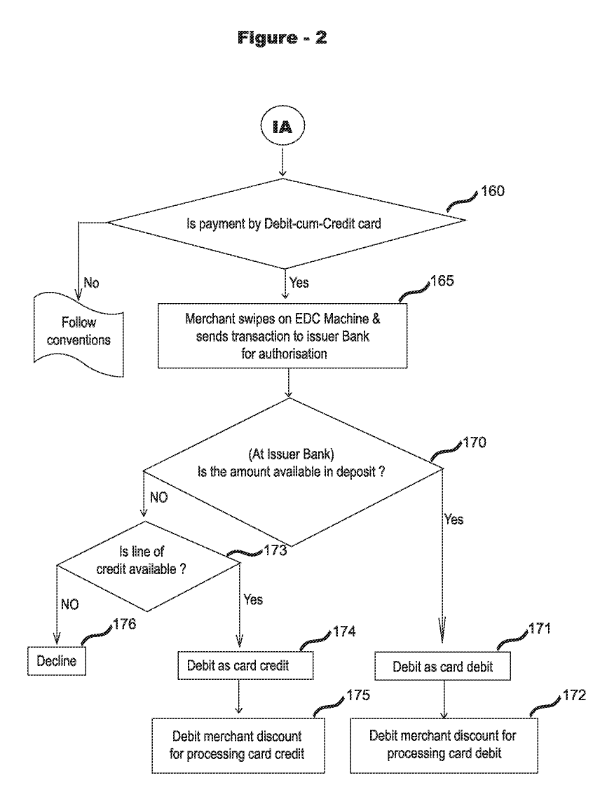

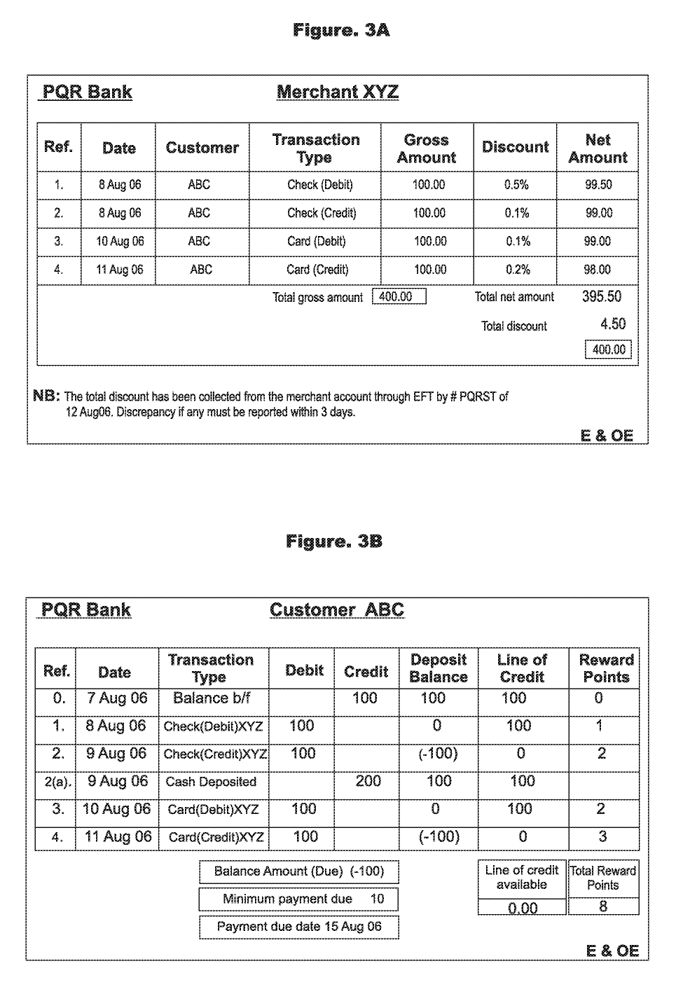

In the best embodiment, the merchant deductions in case of check payments may be lower than those on debit-cum-credit card transactions, because check payment takes more time to collect and there is no direct cost like electronic switch cost involved in card payments. Thus, there may be four levels of deductions e.g. 1% from checks processed as credit, 0.5% from checks processed as debit, 2% from card processed as credit and 1% from card processed as debit. In this case, the deduction on guaranteed checks such as traveler's checks can be same as or different from any of these levels, say, 2.5%. Further, a different level of reward incentive may be awarded in each case to the consumer. Such reward incentive if awarded by the issuer bank may be directly related to such deductions received from the merchant. However, if the incentive is funded by the merchant, the same is inversely related to such deductions. FIGS. 3A and 3B depict an example customer ABC having such an account with bank PQR with a line of credit of $100 and making four payments of $100 each to merchant XYZ, in above four situations. As per FIG. 3A examples the merchant discount varies depending on the type of transaction and the total merchant discount of $4.50 is collected from the merchant (NB). Likewise, as per FIG. 3B examples the consumer reward points vary according to type of transaction, assuming that the rewards are issued by the consumer's bank as above. An interest at a specified rate say 18% p.a. may be levied periodically say monthly on amount paid from the line of credit (not shown).

In one of the embodiments, if the deposit available is lower than the par value of the check presented but the line of credit is sufficient to cover the shortfall, the deposit available may be processed as debit and the rest of the amount as credit, breaking down the transaction in two parts and treating each part preferably as above.

One of the major advantages of the above is that bank accounts in the existing banking and associated payment systems are utilized for both debit and credit transactions whereas at present these are typically utilized for debit type transactions only while the credit transactions at the POS are exclusively handled through different credit card payment systems such as VISA, MC, Discover etc. As a result the customer has to maintain and keep track of only one account for debit and credit transaction, automatically utilizing debit first if available and credit only if not. Checking accounts and check payments which are losing ground to cards can be popularized again by levying a processing fee on the merchant which can be preferably lower than card transactions and rewarding the consumer for using checks, with a reward which can be greater than in case of conventional card transactions.

The above disclosures also make it possible to integrate a credit card utility with a conventional debit card, leading to many benefits for various parties involved in the transaction. The customer benefits include ease of handling due to a single card instead of two different cards, not having to track funds available for debit transactions, making sure that as long as the funds are available credit is not taken and earning rewards on all payments including by checks. Merchant benefits include instant fund transfer and lesser risk of charge-backs. Bank's benefits include independence from the credit card networks and greater utilization of their payment system networks presently utilized only for debit and ATM type transactions. Banks can earn a better interchange discount on check and card transactions. This may lead to overall economic efficiency and lowering of payment processing costs.

In yet another aspect of the invention, a new method for check payment on computer networks such as on Internet is disclosed. At present, third party payment service providers offer check payment services on Internet. It involves filling up a form mimicking a check on a computer graphic user interface (GUI). The MICR details are required to be entered by the user from an original check. The issuer is generally asked to void the check and not use it again. There is no possibility of the payer manually signing the check being paid, though a digital signature like a PIN may be required. Such transactions are cleared through Automated Clearing House (ACH) as Electronic Fund Transfer (EFT) transactions e.g. under the SEC code WEB of NACHA.

In the USA, under Check 21 laws, a substitute check can be deposited, presented or returned as a legal equivalent of the original check. Such substitute check may be created using an electronic image of the original check. Some banks e.g. Chase™ provide remote deposit service on the Internet limited to certain corporate clients depositing the paper checks received by them, through their network terminals acting like a branch of the bank. But there is no known method of making a real check payments with manually written and signed instrument of a consumer in an Internet eCommerce context, as disclosed below:

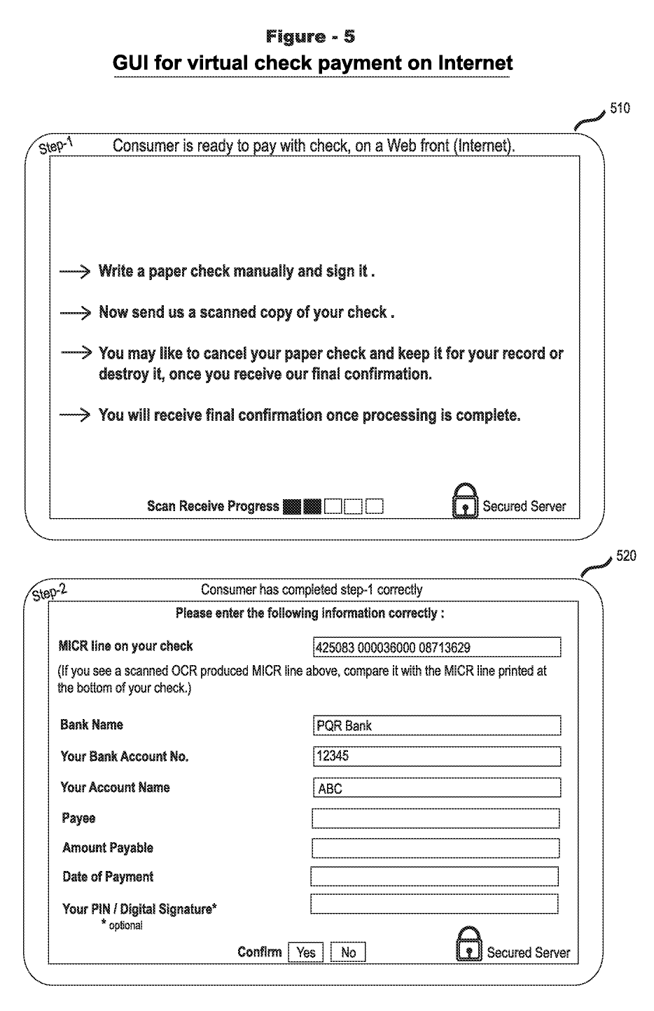

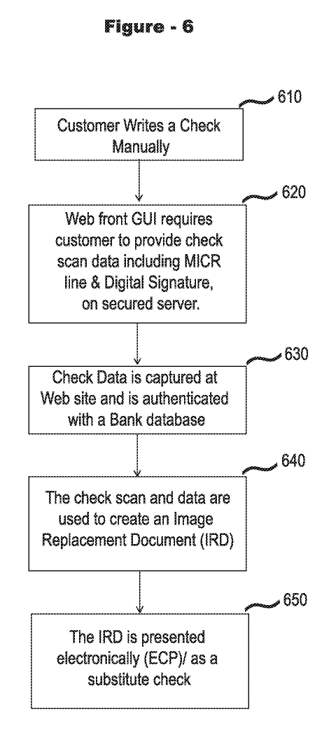

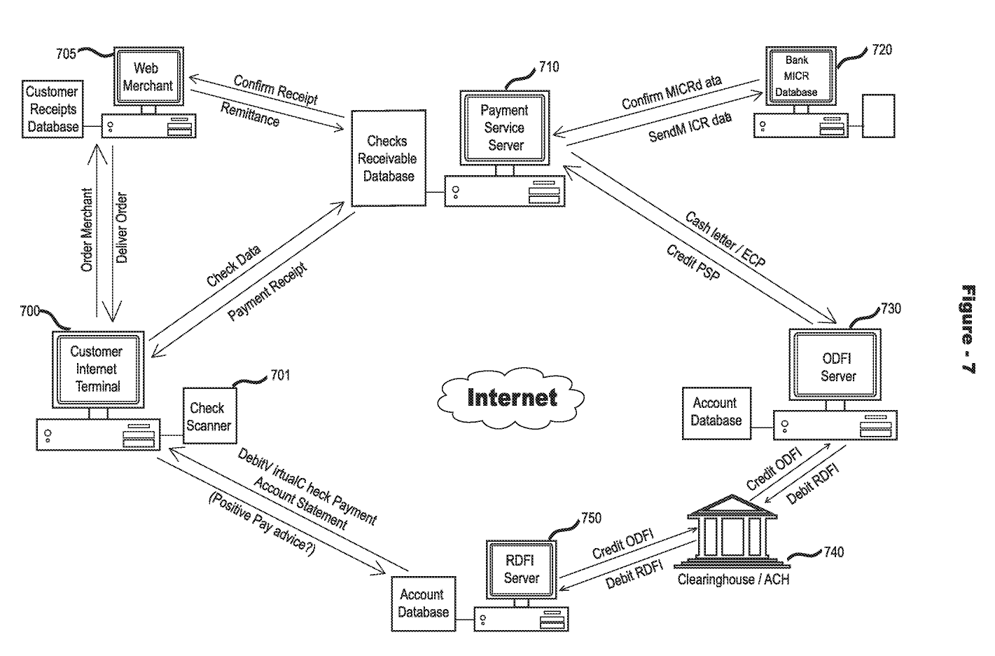

According to a new method proposed here as per FIG. 6, an original Check (610) is written and scanned at consumer's terminal and the scanned image is encrypted and submitted to a payment gateway on a secured server on the Internet. The payment gateway GUI reflected at the consumer terminal (shown in FIG. 5) asks him to provide the check scan and confirm data such as the payee, amount, date, MICR codes and a digital signature manually (620). The digital signature requirement may be in the form of a password, PIN, challenge-response, etc, as is done in web transactions. However, in an alternative embodiment the digital signature requirement may not be there or may be optional depending on payer's or his bank's preference, as shown in FIG. 5 for example. Some of the data like MICR can be generated by OCR software at gateway server and may be pre-populated in the respective field, and is required to be confirmed or corrected manually by the consumer. For example, assuming that the check used is the one shown in FIG. 4A, the MICR numbers on it are shown populated in FIG. 5. The check data may be checked with a bank database (630) or a verification service maintaining valid MICR route numbers and other data for potentially bad checks, e.g. National Check Network®. The check image captured and the data verified can be used for creating an image replacement document (IRD) and processed by electronic check presentment (ECP) or as a substitute check (650). Alternatively, the IRD may be used for supporting an EFT through the ACH or another payment system e.g. VISA-POS.

A checkbook register may be specially provided for such transactions, larger in size (say 50% larger than conventional check size) and the MICR codes may be printed in font size larger than conventional 12 points e.g. 18 points, on white background, for better scanning and OCR. The image so captured including the MICR may again be reduced to standard size (12 points) while making the IRD. Such a checkbook can preferably have haphazard check numbering (e.g. randomly generated) and not serial numbering; like conventional checkbooks, to further avoid fraud. Each check number can be authenticated with the issued and used check numbers in a database of the issuer bank. The advantage will be that if the number of a used check is intercepted by mischief, the same cannot be used to anticipate the number of an unused leaf in the book. Conventional security measures like data encryption, double encryption, challenge response, PIN codes, biometrics etc. may be additionally used to enhance security. The transmitted check image can be tested for image faithfulness, defects, quality and usability and disallowed if not within a defined range as per required metrics and standards. The image can be compressed e.g. in JPEG format, at the time or sending. Conventional desktop scanners such as those manufactured by HP™ or specialized check scanners designed to conform Check 21 standards may be used. The scanners and the associated program may have the capability of rejecting a check not written on a original check form e.g. written on a copy of an original check leaf.

In one of the embodiments, the check in this process of Internet process may be the special check disclosed above as per FIGS. 4 A and 4B.

The main advantage will be due to the writing of an original check and capturing its image. As a result, the web transaction, will be supported by an IRD of an original check with payer's signature, unlike a conventional electronic check transaction, which only rely on MICR data and thus may be more prone to frauds. Then it can be also presented electronically under Check 21 rules, which are more payee friendly because they are governed under negotiable instrument laws such as UCC of USA, rather than ACH-WEB transaction standard used at present which are governed under EFT laws such as Regulation E. However, even if such transactions are presented through ACH, the novel step of requiring the payer to actually write a check and send a scan to the payee gateway will be advantageous in providing a better and more reliable record and evidence of the transaction, to all parties. Moreover, capturing the image of a manually signed check may make it possible to present the transaction as ACH-ARC truncation such as in lockbox conversions where image check must be captured and original check destroyed. In this case since the original check stays with the consumer signing the check, it will provide a better protection to the payee parties, because if the consumer dispute the payment, he may be required to show if the original check form with the same number was issued to him, was it not used or used differently by him.

Such a payment service provider on the Internet e.g. a payment gateway can also build on experience new protocols for checking the integrity of such check payments, e.g. signature verification based on past checks honored, at the first instance, before accepting the check for presentment.

The web front will ask consumer to send a scanned image of the actually written check. In addition, the consumer may be also asked to fill up and confirm check data such as payee, amount, MICR codes etc through his electronic keyboard. The keyboard or an additional device may have a specialized scanner to scan the check including the MICR line and the backside. If the image is unfit as per check 21 requirements e.g. due to low resolution, the check may then be converted as ACH-ARC or POP, with the consent of the consumer. ARC transactions are allowed in writer not present situation such as lock-box collections, in which case the image of the check must be retained for two years and the original check shredded within 14 days. These requirements can be met as per the disclosures here, as the check writer must scan and send the image. If the image quality conforms to X9 standards of Check 21, it may then move as a substitute check rather than ACH entry, in the clearing process. Desktop scanners or special check scanners may be provided for this, at consumer terminal. The original check may be cancelled, retained or destroyed by the writer or may be required to be submitted in cancelled condition to the payment service provider, as per a contract. In one of the embodiments, the scanned image of the check may be printed out at the payment gateway as an image replacement document (IRD) to be used in the conventional clearing under check 21 laws. In yet another embodiment such an IRD may be again converted into an electronic payment instruction transacted on ACH or card payment systems such as those used in Electronic Fund Transfer (EFT) systems, debit cards and credit cards e.g. VISA POS etc. In that case, the advantage will be a real manually signed IRD check as an additional proof of payment instructions, reducing chances of fraud. X9.100-140 provides standards for IRD. X9.100-180 standard establishes the file sequences, record types and field formats to be used for the electronic exchange of check MICR line data, associated check processing data, check images and optional user information in the form of cash letters. The scanned image of the check transmitted by the consumer on a web front may be used for creating a substitute check image or an IRD, as per these standards, utilizing software and hardware tools installed at the web based payment service provider gateway acting as a corporate remote depositor or an originating deposit financial institution (ODFI) or a bank of first deposit (truncating bank) that is going to present the check in the clearing process, to a paying bank. Alternatively, a batch of such checks may be presented as an Cash Letter or an Image Cash letter.

FIG. 7 is a scheme diagram showing an example arrangement. A consumer through his Internet terminal (700) orders to a web merchant (705), which in turn is connected to a payment service provider (PSP) server (710). The customer makes the payment as explained earlier (FIGS. 5 & 6) through a manually written check, to the PSP. The PSP authenticates the check data with a bank database (720) and deposits transaction to his bank also known as originating deposit financial institution (ODFI), which presents it to a consumer's bank (750) also known as receiving deposit financial institution (RDFI), via clearinghouse (740). The payer's bank debits him and credits the payee in a reverse flow as shown. The customer may also have communicated to his bank in advance to honor the check by what is generally known as a positive pay advice.

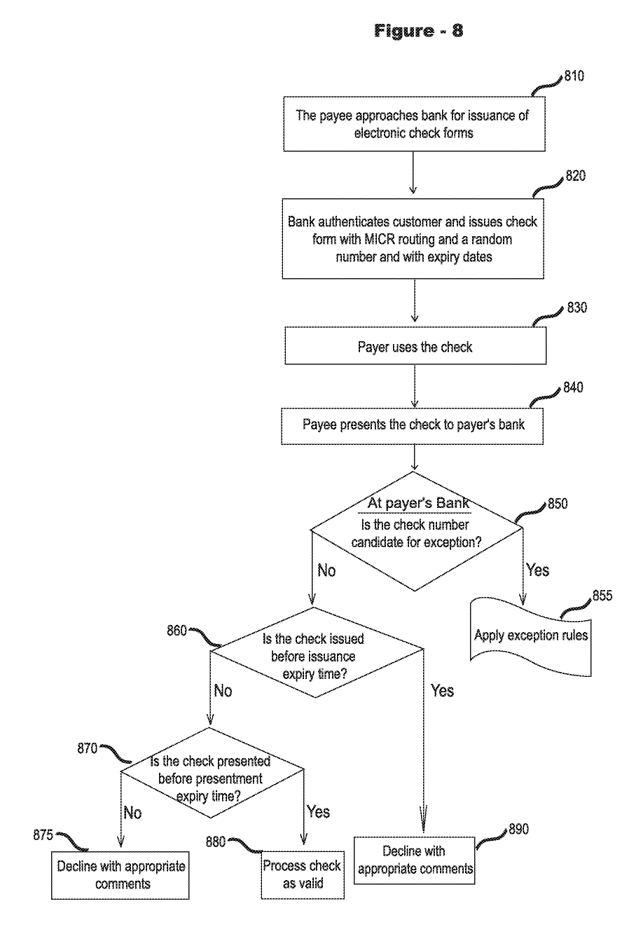

In one embodiment, as per FIG. 8, an electronic image check form with unique check number may be issued by a bank in response to a requisition by an account holder (810). This may be in the form of an electronic file which may be encrypted and transmitted to the account holder electronically either to his remote terminal through a network like Internet or on a device like an electronic pad e.g. a PDA (820) or through a wireless device such as a cell phone. The user may then decrypt and print such image to write a check and then scan and transmit the check as mentioned above (830). Alternatively, the check may be written electronically and signed electronically using an electronic pen device known in the art. Each time a unique check number may be generated for example randomly, and the same remains in the bank server memory. Further, expiry rules can be set e.g. to be used within 1 hour and presented within 48 hours if the check-form is issued on the Internet. The payer's bank program when presented with the transaction as explained above will first check the authenticity of the check data including its number and then check the expiry protocols (860-890). The advantage will be that since each check is tied to a unique check number issued by the bank, if a check so used is intercepted and deciphered, neither can be another check number anticipated, nor can the same check number be used again in a transaction, reducing the chance of fraud dramatically, compared to known Internet payment methods for eCommerce which rely on a account number and PIN etc. which if intercepted and deciphered are like a lost key which can be used for defrauding multiple times in multiple transactions. However, if a blank check form is intercepted and deciphered, it is likely that the legitimate user will also respond in some way or the other simultaneously, and thus a fraudulent transaction will more likely arouse suspicion and can be flagged as per exception rules (855) to mark suspects and avoid frauds. For example, the flagging for exception can be done if a) the account holder has stopped payment, b) more than one checks have been simultaneously presented with same check number, c) Signature differing, d) Amount being above a specified maximum for such checks e.g. 1000 dollars, e) the payee account being in a black list, f) the check number is not issued to the customer, etc. Due to instant issuing and tight expiry rules of the electronic check forms issued, the potential of delayed misuse is virtually ruled out, which is a major improvement over the present methods of internet check payments where a hacker intercepting a genuine transaction can anticipate likely unused check numbers in the same serial and thus having long validity, due to those being serially numbered and not being tied to expiry rules. Though this process is explained in the context of all electronic issuance of the check forms, a similar method may be applied while issuing paper checks, suitably modified e.g. expiry period from issuance being in weeks or months rather than hours or days.

Since third party checks conversion may not be allowed as per clearinghouse rules, the checks may be required to be drawn in favor of gateway rather than the merchant vendor. In that case the gateway may maintain accounts for large vendors and the checks may be required to be in favor of such accounts e.g. Gateway A/c MV etc. The risks of liabilities may be suitably insured based on experience.

Although the present invention has been described in detail here, various changes, substitutions, and alterations may be readily ascertainable by those skilled in the art and may be made herein without departing from the spirit and scope of the present invention as defined in the following claims. Moreover, the present invention is not intended to be limited in any way by any statement in the specification that is not otherwise reflected in the appended claims.

What is claimed is:

1. A computerized financial process for payment with traveler's checks comprising:
receiving consideration and issuing a negotiable instrument in the form a traveler's check with associated rewards, to a consumer
being presented by a merchant's bank such check used by the consumer for payment to the merchant
paying the merchant at par value of the check presented through clearing and settlement at par with the merchant's bank
debiting, invoicing and collecting from the merchant a discount for processing the payment, as per contract

2. The process of claim further comprising:
funding a reward incentive to the consumer from such discount collected, applying data processing means

3. The process of claim 17 the step of debiting, invoicing and collecting from the merchant a contracted discount for processing the payment is modified in that;
contracting a merchant's bank for retaining the merchant discount form the par value of the check
allowing a service fee to be deducted by the merchant's bank for retaining such discount, and
collecting the net of the said merchant discount retained after deducting the said service fee, from the merchant's bank, through account reconciliation and settlement, applying data processing program means

4. The process of claim 1, further comprising;
issuing the traveler's check of a specific amount against holding the amount locked in an interest earning bank deposit account and debiting the amount on being presented the check by a payee.

5. The process of claim 4, further comprising;
issuing the traveler's check of an amount from a line of credit extended to a bank account holder and debiting the amount as an advance lent at a specified interest rate, on being presented by a payee.

6. The process of claim 1, further comprising;
providing the payer facility to write an amount on the said traveler's check, the said amount being lower than or equal to a maximum guaranteed value of the check imprinted on it, along with an instruction that the amount of the check may not be above such guaranteed amount

7. The process of claim 1, further comprising;
the said check is in the form of a guaranteed check including a banker's check

8. A computerized financial process of awarding reward incentives on payment with checks, comprising:
enrolling a consumer in a reward incentive program for payment with checks issued against a checking account in a financial institution
being presented by a merchant's bank such check used by the consumer for payment to the merchant
paying the merchant proceeds of the check presented, through clearing and settlement at par with the merchant's bank
debiting, invoicing and collecting from the merchant a contracted discount on processing the payment

9. The process of claim 8, further comprising;
issuing a reward incentive to the consumer, funded by a portion of such discount collected

10. The process of claim 8, the step of debiting, invoicing and collecting from the merchant a contracted discount for processing the payment is modified in that;
contracting a merchant's acquirer bank for retaining the merchant discount from the par value of the check
allowing a service fee to be deducted by the merchant's bank for retaining such discount, and
collecting the net of the said merchant discount retained after deducting the said service fee, from the merchant's bank, through account reconciliation and settlement, applying data processing program means

11. A computerized financial process for a debit-cum-credit checking account comprising:
opening a deposit checking account with a line of credit to a consumer
receiving payment from the said consumer through a check issued to a merchant
being presented with the check by the merchant's bank to the issuer bank, through banking clearinghouse
determining if there is sufficient fund available in the deposit account and if such fund is available processing the transaction as a debit entry, and if the fund is insufficient but within the line of credit
processing the transaction as a credit advanced to the said consumer
debiting, invoicing and collecting from the merchant a first contracted discount on processing the payment as debit and a second contracted discount on processing the payment as credit

12. The process of claim 11 further comprising;
rewarding the consumer with a first incentive if the payment is processed as a debit and a second incentive if the payment is processed as a credit

13. The process of claim 11, the step of debiting, invoicing and collecting merchant discounts is modified in that;
contracting a merchant's acquirer bank for retaining the merchant discounts from the par value of the check
allowing a service fees to be deducted by the merchant's bank for retaining such discounts, and
collecting the net of the said merchant discounts retained after deducting the said service fees, from the merchant's bank, through account reconciliation and settlement, applying data processing program means

14. A computerized financial process for receiving payments through a Debit-cum-Credit card comprising:
opening a deposit account with a line of credit to a consumer and providing him with a credit-cum-debit card linked to the said account at an issuer bank
receiving payment through the said card from the said consumer at a merchant terminal; inputting the card information and the amount and transmitting it to the issuer bank, through a payment system network means
determining if there is sufficient fund available in the deposit account
processing the transaction as a debit transaction and deducting a first merchant discount, if such fund is available
processing the transaction as a credit transaction and deducting a second merchant discount if the fund is insufficient but within the line of credit; applying data processing program logic means

15. The process of claim 14, further comprising;
rewarding the consumer with a first incentive if the payment is processed as a debit and a second incentive if the payment is processed as a credit.

16. Combined process of claim 11 and 14, comprising;
opening a deposit checking account with a line of credit to a consumer, by an issuer bank
issuing options to the consumer to pay by checks and a debit-cum-credit card
receiving payment from the said consumer through a check or card, at a merchant
being presented with the transaction by the merchant's bank to the issuer bank
determining if there is sufficient fund available in the deposit account and if such fund is available processing the transaction as a debit entry, and if the fund is insufficient but within the line of credit
processing the transaction as a credit advanced to the said consumer
debiting, invoicing and collecting from the merchant as per contract, a first discount on check debit, a second discount on check credit, a third discount on card debit and a fourth discount on card credit.

17. The process of claim 16, further comprising;
rewarding the consumer with a first incentive if the payment is a check debit, a second incentive if the payment is a check credit, a third incentive if the payment is a card debit and a fourth incentive if the payment is a card credit.

18. The process of claim 16 further comprising;
determining, if the deposit available falls short of the transaction, whether the shortfall is lesser than or equal to the line of credit available, and if so;
processing the deposit available as a debit and the shortfall as a credit

19. The process of claim 16 further comprising;
the payment is made electronically on a computer network including Internet

20. A method of making check payments on a computer network including Internet comprising:
being issued checks with MICR codes, for use in electronic payments to a payee, on a computer network including Internet
manually writing on such a check a payee, an amount, a date and a signature
scanning the manually written check with scanner means, encrypting the said scan and sending to a payee, on a secured server applying software means
being presented with a confirmation of the receipt of the said scan and also being presented with a form for manually entering and confirming check data, through a GUI means
manually entering and confirming the said check data, including the said payee, the said amount, the said date and the said MICR codes, through a keyboard, through a GUI means
the said check scan and the said check data being used to create an image replacement document or a substitute check image
the said image replacement document or substitute check image being processed through bank clearing

21. The method of claim 20 further comprising;
including in the manually entered data an encrypted digital signature

21. The method of claim 20 further comprising;
the said processing is through Automated Clearing House (ACH), and as an Accounts Receivable Conversion (ARC) or a Point of Presentment (POP) conversion.

22. The method of claim 20 further comprising;
the said processing is through a card payment system.

23. The method of claim 20 further comprising;
printing and issuing special checks with white background and with enlarged MICR fonts

24. The method of claim 20 further comprising;
issuing check leaves for such transactions each with a unique check number, formed in a checkbook in which such check numbers are not serially numbered.

25. The method of claim 24 further comprising;
issuing the check leave in the form of an encrypted electronic image, with a check number being electronically generated by the bank software program and transmitted to a payer's electronic device means
the said electronic check number being tied to an expiration rule for issuance and presentment in the bank server database

26. The method of claim 20 further comprising,
the check is a travelers check on which a merchant discount is debited and collected as per claim 1.

27. The method of claim 20 further comprising,
the check is a check of claim 8, on which a merchant discount is debited and collected.
